(19) United States
(12) Patent Application Publication
(10) Pub. No.: US 2025/0382425 A1
(43) Pub. Date: Dec. 18, 2025

(54) Method for preparation of lignin-based latex for binding and coating applications

(71) Applicant: Åbo Akademi, Åbo (FI)

(72) Inventors: Luyao Wang, Åbo (FI); Xiaoju Wang, Åbo (FI); Patrik Eklund, Åbo (FI); Rajesh Koppolu, Åbo (FI); Martti Toivakka, Åbo (FI); Chunlin Xu, Åbo (FI)

(21) Appl. No.: 18/878,096

(22) PCT Filed: Jun. 21, 2023
(86) PCT No.: PCT/FI2023/050375

§ 371 Date: Dec. 23, 2024

(30) Foreign Application Priority Data
Jun. 23, 2022 (FI) 20225569

(51) Int. Cl. C08H 7/00; C08J 3/205

(52) U.S. Cl. CPC C08H 6/00; C08J 3/205

(57) ABSTRACT

According to an example aspect of the present invention, here is provided a lignin ether grafted with poly(alkyl acrylate), a latex comprising a lignin ether grafted with poly(alkyl acrylate), and a method of manufacturing a biobased latex comprising the steps of providing an allylated lignin ether derivative and grafting the allylated lignin ether derivative with a poly(alkyl acrylate) by emulsion polymerization, a biobased film formed by the said latex or said method and the use of the latex.

### FIELD

The present invention relates to an ether derivative of lignin. In particular the present invention concerns novel lignin-based latexes, especially, lignin-nanoparticle-based latexes, their preparation method and their uses for binding and coating applications.

### BACKGROUND

Paper and paperboard are renewable packaging materials but they do not as such have the required barrier properties to provide protection for example against moisture, oxygen, volatile aroma, grease and oil, as well as impact of light. At present, the required barrier properties are achieved especially by extrusion plastics (e.g. polyethylene), aluminium, and/or fluorochemicals, resulting in poor end-product recyclability and increasing safety concerns in food packaging materials. Typically, such barriers used are multilayer films.

Also latexes are commonly used as coating materials. Latexes (elastomers) are soft amorphous polymers, which are commonly formulated as water-based dispersions (latexes) and used in numerous products, e.g., converted paper, packaging materials, coatings, textiles and car tyres. However, the commercial products are mainly oil-based, such as styrene-butadiene, styrene-acrylate and polyvinyl-acetate copolymers.

Currently, fossil fuel-based polymer materials for coating applications put a great threaten to environment and human's health. Thus, there is a pressing need for alternative bio-based polymer materials to replace the source of oil-based materials.

One of the promising approaches is the development of bio-latex coating technology, such as designing natural rubber, starch, protein, hemicellulose, or cellulose functionalized latex dispersions. Vartiainen et al., for example, describe a bio-based multilayer barrier film produced by combining dispersion-coated cellulose nanofibrils, atomic layer deposited aluminium oxide, and extrusion-coated polyglycolic acid.

Also lignin has been researched to be used in rubber based materials to replace conventional rubber filler carbon black. However, it has been noted that lignin shows little or no reinforcing effect if directly mixed with rubber, presumably due to large particle size and lack of strong interfacial interactions between lignin and rubber matrix. Thus, lignin modification and hybrid fillers have been researched as an option. Jiang et al. have also used high temperature dynamic heat treatment in order to improve interaction between lignin and rubber. No optimal solution has been found.

Messmer et al. describe the effect of lignin treatment with tert-butyl hydroperoxide and sodium formaldehyde sulfoxylate on the properties of the latexes produced by emulsion copolymerization of styrene with n-butyl acrylate and methacrylic acid, with initiator introduced in a shot process.

One of the biggest challenges for bio-based barrier and binder coatings is simultaneously meet two contradictory requirements, the first being a low film formation temperature (less than 15° C.) that ensures the formation of smooth and flexible film at room temperature. The second being a sufficient film blocking resistance and film hardness, which are usually achieved by polymers with a glass transition temperature (T_{g}) higher than room temperature. Typically, the softer the polymer, the worse is the hardness and the higher is the blocking tendency, which restricts the performance and production efficiency of the barrier coating. Thus, the contradiction between these two properties typically results in compromised material properties.

Thus, there is a need to improve the functional properties of biopolymers for more demanding packaging applications. In particular, there is a clear need for new thermoplastic bio-based elastomers to replace the petroleum-derived synthetic polymers which are the main ones currently in use.

### SUMMARY OF THE INVENTION

It is an aim of the present invention to reduce or even completely eliminate the above-mentioned problems encountered in the art.

This invention provides a lignin ether grafted with poly(alkyl acrylate). The lignin derivative is in particular obtained by introducing, via ether bonds, groups containing unsaturated bonds onto the lignin backbone, and by then reacting the derivative exhibiting unsaturated bonds with a reactant containing acrylate groups. By copolymerizing the modified lignin with a specific poly(alkyl acrylate), for example via emulsion polymerization, a lignin-based latex can be provided which is suitable for various end-use applications. Thus, it has been surprisingly found in the present invention that such lignin derivative provides improved barrier and binding properties despite of inherent heterogeneity of lignin.

The lignin-based latex finds uses in the paper, paperboard and packaging industry as well as broader coating and surface treatment products.

More specifically, the invention is defined by the features of the independent claims. Some specific embodiments are defined in the dependent claims.

According to a first aspect of the present invention, there is provided a lignin ether grafted with poly(alkyl acrylate).

According to a second aspect of the present invention, there is provided a latex comprising a lignin ether grafted with poly(alkyl acrylate).

According to a third aspect of the present invention, there is provided a method of manufacturing a biobased latex, comprising the steps of providing an allylated phenolic ether derivative of lignin; and grafting the allylated lignin ether derivative with a poly(alkyl acrylate) by emulsion polymerization.

According to a fourth aspect of the present invention, there is provided a biobased, water-borne latex formed by a method comprising the steps of providing an allylated phenolic ether derivative of lignin; and grafting the allylated lignin ether derivative with a poly(alkyl acrylate) by emulsion polymerization.

According to a fifth aspect of the present invention there is provided a biobased film formed by a water-borne latex comprising a lignin ether grafted with poly(alkyl acrylate) or a method comprising the steps of providing an allylated lignin ether derivative; and grafting the allylated lignin ether derivative with a poly(alkyl acrylate) by emulsion polymerization.

According to a sixth aspect of the present invention there is provided uses for latexes.

More specifically the present invention is characterized by what is stated in the independent claims.

Considerable advantages are obtained by the invention.

The present invention provides a sustainable and safe barrier coating comprised of lignin-nanoparticle-based latex dispersion, especially for fiber-based packaging materials. Use of lignin, the most abundant aromatic bioresource, to replace fossil-based chemicals reduces the environmental footprint of the packaging material thereof, and further improves recyclability of fiber-based packaging materials. Further, the non-toxicity of lignin in combination with its natural antioxidant activity, hydrophobicity and ultraviolet-shielding property provides a safer alternative for harmful aluminium or fluorochemicals in providing protection against oxygen, water vapour, oil, grease and light impact.

The lignin nanoparticles of spherical shape also enhances colloidal stability compared to bulk lignin and other biopolymers. In addition, lignin nanoparticles are functionalized with polymerization locus, which will co-polymerize with acrylic monomers and benefit the quality and runnability of the latex dispersion and further ensure the formation of a smooth and uniform layer.

The latex barrier coating technology of the present invention also enables the production of cost-effective products on-site with fewer production steps compared with applying extrusion plastics. Further, the method enables tailoring of the barrier properties to specific end-use requirements, and it also enables development of barrier coating formulations that adapt to all kinds of paper machines.

The present invention overcomes the challenges of the prior art with a unique latex morphology with soft-shell of acrylic polymer (with low T_{g}) and spherical hard-core lignin nanoparticles (with high T_{g}). Thus, the material of the present invention satisfy both the demand of a low film formation temperature and a sufficient flexibility of the barrier layer thus providing blocking resistance and required film hardness. Such is not achieved with a latex absent of a core-shell structure.

The allylated lignin ether derivative shows good binding properties, and films prepared from it have high flexibility with extensional strain up to 3000% and hydrophobicity with water contact angle up to 90°, as well as high transparency. In the packaging industry, high transparency is usually desirable to enable the visibility of coated products.

Further features and advantages of embodiments will become evident from the following description of preferred embodiments in which reference is made to the attached drawings.

### BRIEF DESCRIPTION OF THE DRAWINGS

FIG. 1 is a schematic depiction of the preparation of (a) A-LNPs and (b) A-LNPs-co-BA-MMA latex in accordance with at least some embodiments of the present invention.

FIG. 2 shows TEM images of A-LNP samples in accordance at least some embodiments of the present invention.

FIG. 3 shows ³¹P NMR spectra of A-LNPs, including birch-i-PrOH lignin.

FIG. 4 shows TEM images of latex in accordance at least some embodiments of the present invention.

FIG. 5 is a schematic depiction of the proposed process of bio-latex formation via lignin nanoparticle seeded free radical emulsion polymerization in accordance with at least some embodiments of the present invention.

FIG. 6 shows film cast from latex dispersion in accordance at least some embodiments of the present invention.

FIG. 7 shows DSC curves of bio-latex films in accordance with at least some embodiments of the present invention.

FIG. 8 shows AFM images of bio-latex films in accordance with at least some embodiments of the present invention.

### EMBODIMENTS

### Definitions

In the present context, the term “biobased” refers to a material that comprises, consists or essentially consists of a substance (or substances) derived from living matter (biomass) and either occur naturally or are synthesized. In some embodiments, a part or all of the biobased material or biobased raw-materials are obtained from renewable sources, such as from biomass, including lignin.

As used herein, the term “average particle size” refers to the intensity weighted average hydrodynamic diameter.

As used herein, the term “about” refers to the actual given value, and also to an approximation to such given value that would reasonably be inferred to one of ordinary skill in the art, including approximations due to the experimental and/or measurement conditions for such given value.

Unless otherwise stated, properties that have been experimentally measured or determined herein have been measured or determined at room temperature.

Unless otherwise indicated, room temperature is 23° C.

Unless otherwise stated, properties that have been experimentally measured or determined herein have been measured or determined at atmospheric pressure.

In the present context, the expression “unsaturated groups” stands for groups which exhibit unsaturated bonds, such as double or triple bonds, either one or more per group—in case of several unsaturated bonds they may be conjugated or isolated—and which are capable of reacting with other groups, in particular with other groups of similar kind. In one embodiment, the groups have a double or triple bond.

According to an embodiment there is provided a lignin ether grafted with poly(alkyl acrylate).

According to one embodiment, the lignin ether is obtained by grafting poly(alkyl acrylate) to lignin ether derivative, in particular to allylated lignin ether derivative. In one particular embodiment, the lignin ether is obtained by grafting poly(alkyl acrylate) to allylic ether groups on the lignin.

According to an embodiment the biolatex is obtained by grafting poly(alkyl acrylate) to allylic ether groups on the lignin.

According to one embodiment, the poly(alkyl acrylate) is grafted to allylated lignin ether derivative obtained by reacting lignin exhibiting phenolic hydroxyl groups with a bi-functional reactant. In a preferred embodiment, the bi-functional reactant contains epoxy groups and unsaturated groups, in particular vinyl or allyl groups.

According to an embodiment the poly(alkyl acrylate) is grafted to ether groups on the lignin, in particular allylic ether groups, which are obtained by reacting the lignin exhibiting phenolic hydroxyl groups with a bi-functional reactant containing epoxy groups and unsaturated groups, in particular vinyl or allyl groups.

Thus, according to one embodiment, hydroxyl groups of lignin are functionalized by using especially allyl ether. Preferably, such functionalization is carried out by an anionic ring-opening reaction under alkaline conditions.

In the present context, the term “degree of substitution”, abbreviated “DS”, refers to the average amount of substituent groups (mmol) attached per gram of the derivative of lignin.

According to an embodiment the poly(alkyl acrylate) graft is obtained by polymerization, in particular by free radical polymerization, of an alkyl acrylate monomer or an alkyl (alk)acrylate monomer or a combination thereof, in the presence of the lignin ether. In particular alkyl-acrylate monomer is selected from the group of ethyl acrylate, n-propyl acrylate, isopropyl acrylate, n-butyl acrylate and isobutyl acrylate and combinations thereof, whereas the alkyl (alk) acrylate monomer is preferably selected from the group of methyl methacrylate, n-hexyl methacrylate, n-octyl methacrylate and isooctyl acrylate monomers and combinations thereof. Preferably, the monomer is selected from the group of monomers, which yield homopolymer that have low glass transition temperature, for example their glass transition temperature is between −80° C. and 20° C., such as −60° C. to 10° C. or as −50° C. to 0° C., and which monomers have hydrophobic long alkyl groups. “Long alkyl groups” refer to alkyl groups having 4 to 30 carbon atoms, in particular 8 to 24 carbon atoms.

In other words, according to one embodiment a bi-functional monomer preferably containing reactive groups and unsaturated groups, is used for reacting with hydroxyl groups of lignin to introduce double bonds onto lignin molecular structure. Then the modified lignin is copolymerized with a poly(alkyl acrylate), for example via emulsion polymerization, such as the pre-emulsified semi-continuous emulsion polymerization method, to synthesize the lignin-based hybrid latex for the end-use applications.

According to one embodiment, the bi-functional reactant can be any reactant comprising reactive groups and unsaturated groups. In particular, the reactive groups are epoxy groups or alkyl halide groups, whereas the unsaturated groups are vinyl and/or allyl groups. The bi-functional reactant comprising epoxy groups and vinyl and/or allyl groups can be for example allyl glycidyl ether containing epoxy groups and allyl groups. The bi-functional reactant comprising alkyl halide groups and vinyl and/or allyl groups can be for example allyl bromide or allyl chloride or a mixture thereof.

According to one embodiment, the bi-functional reactant is selected from the group of allyl glycidyl ether, allyl bromide and allyl chloride and mixtures thereof.

Thus, in one embodiment, a bi-functional monomer, such as allyl glycidyl ether containing epoxy groups and vinyl/allyl groups, is introduced and chemically bonded to a lignin through etherification. Then the allylated lignin is grafted with an alkyl acrylate monomer to prepare lignin-nanoparticle-based latexes for coating applications for example using pre-emulsified semi-continuous emulsion polymerization.

For the present purpose, the term “pre-emulsified semi-continuous emulsion polymerization” stands for a continuously operated emulsion polymerization process, in which the monomers to be fed into the polymerization are pre-emulsified separately before they are feed in the polymerization reaction.

According to one embodiment, the allylic lignin ether is subjected to copolymerization with a combination of alkyl acrylate and alkyl (alk)acrylate monomers. According to one embodiment said combination comprises alkyl acrylate and alkyl (alk)acrylate monomers at a molar ratio of 20:80 to 80:20 or 30:70 to 70:30, such as 35:75 to 75:35, for example 35:75 to 40:60, for example 44:56.

The poly(alkyl acrylate), particularly n-butyl acrylate, can be obtained from fully biomass resources based on the bio-based alcohol fermented from glucose and the bio-based acrylic acid converted from lactic acid. By using biomass resources, the biomass content accounted for in the ready product is up to 70%, especially up to 62%.

The lignin can be any lignin. However, according to a preferred embodiment the lignin is selected from the group of unmodified lignin, alkali lignin, non-sulphurous lignin, Organosolv lignin, Kraft lignin, LignoBoost lignin or LignoForce lignin.

Lignin used in the present invention is especially lignin obtained from a biomass, such as wood or annual or perennial plants or, correspondingly, lignin obtained from lignocellulose. In particular, material isolated from spent liquor obtained from cooking of biomass is used as the lignin starting material.

As examples of lignin starting material to be used, mention may be made of lignin isolated from biomass by an alkaline cooking process, such as kraft lignin (i.e. lignin from sulphate process) or soda lignin (i.e. lignin from soda pulping). The use of organosolv lignin (i.e. lignin obtained from organosolv pulping) is also possible in the process. As lignin starting materials that can be used, mention can also be made of pyrolytic lignin, steamed lignin, diluted acid lignin and alkaline oxidative lignin.

Mixtures of the above-mentioned lignin starting materials may also be used as the lignin starting material.

In one embodiment, lignin starting material is an alkaline lignin selected from the group of i_PrOH (isopropylalcohol)-soluble fractions from birch, spruce, and/or wheat straw.

According to one embodiment, the lignin ether comprises lignin in which at least 50 mol %, preferably at least 80 mol %, more preferably at least 90 mol %, of the phenolic hydroxyl groups have been converted to allylic ether groups.

According to an embodiment the lignin has a degree of substitution of up to 1.5, in particular up to 1.0, for example of about 0.04 to 0.83, 0.10 to 0.51, or 0.30 to 0.83. The degree of substitution is measured by proton nuclear magnetic resonance with dimethyl sulphoxide, in particular deuterated dimethyl sulphoxide, as solvent.

According to an embodiment the lignin has a number average molecular weight of 2,000-50,000 g/mol, preferably 5,000-20,000 g/mol, in particular 7,000-10,000 g/mol and a weight average molecular weight of 3,000-100,000 g/mol, preferably 5,000-20,000 g/mol, in particular 10,000-20,000 g/mol as measured by a high-performance size exclusion chromatography.

According to an embodiment the allylated lignin has a number average molecular weight of 2,000-50,000 g/mol, preferably 5,000-20,000 g/mol, in particulary 7,000-10,000 g/mol, and a weight average molecular weight of 3,000-100,000 g/mol, preferably 5,000-20,000 g/mol, in particular 10,000-20,000 g/mol, as measured by a high-performance size exclusion chromatography.

According to one embodiment there is provided a latex comprising a lignin ether grafted with poly(alkyl acrylate) as described above.

According to an embodiment the latex has a Z-average particle size of about 120 to 250 nm, for example about 100±20 nm, determined by Zeta-sizer Nano ZS90 type laser nanometer particle size analyzer (Malvern, UK) with a 633 nm red laser.

According to one embodiment, the latex has a T_{g} of 15° C. or less.

According to one embodiment, the latex comprises lignin nanoparticle segments and acrylic polymer particle segments which are chemically or physically bonded to each other, wherein according to a preferred embodiment, the lignin nanoparticles have a hard core, whereas the acrylic polymer particle segments have a soft shell. The soft shell of acrylic polymer with a low T_{g} and hard-core lignin nanoparticles with a high T_{g} form a core-shell structure which enables low film formation temperature in combination with T_{g} higher than room temperature.

The resultant lignin-based emulsions comprise or consist of at least 5% by weight, in particular at least 10% by weight of material obtained from renewable sources. In some embodiments, at least up to 15%, preferably at least up to 40%, in particular up to 50% or more are of such, bio-based raw materials and show good binding to other materials, water-resistance, as well as high film flexibility and transparency.

According to an embodiment the latex has a content of biobased materials of up to 70% by weight, preferably 50-70% by weight, in particular 50-60% by weight, for example 62% by weight, calculated from the solid matter of the latex, provided that the poly(alkyl acrylate) is obtained from biobased raw-materials.

The present invention latex has a solids content of up to 30% by weight measured from the weight of the whole latex material.

According to an embodiment there is provided a method of manufacturing a biobased latex, comprising the steps of providing an allylated phenolic ether derivative of lignin; and grafting the allylated lignin ether derivative with a poly(alkyl acrylate) by emulsion polymerization.

According to an embodiment the allylated lignin ether derivative is obtained by reacting lignin with a bi-functional reactant containing epoxy groups and vinyl groups to chemically bond to lignin by etherification.

According to an embodiment the bi-functional monomer containing epoxy groups and vinyl groups is allyl glycidyl ether.

According to one embodiment, the etherification is carried out in aqueous phase at a pH in the alkaline range.

According to one embodiment, the allylated phenolic ether derivative is subjected to dialysis to lower the pH and to allow for self-assembly of the ether derivative.

According to one embodiment, the allylated lignin nanoparticles are self-assembled from lignin solution, preferably allylated lignin particles are self-assembles as spherical lignin nanoparticles.

According to an embodiment the alkyl-acrylate monomer is selected from the group of ethyl acrylate, n-propyl acrylate, n-butyl acrylate, isopropyl acrylate, n-butyl acrylate, isobutyl acrylate, methyl methacrylate n-hexyl methacrylate, n-octyl methacrylate and isooctyl acrylate monomers and combinations thereof.

According to one embodiment, the method comprises copolymerizing a combination of alkyl acrylate and alkyl (alk)acrylate monomers, said combination comprising alkyl acrylate and alkyl (alk)acrylate monomers at a molar ratio of 20:80 to 80:20 or 30:70 to 70:30, such as 35:75 to 75:35, for example 35:75 to 40:60, in the presence of an allylated phenolic ether derivative of lignin.

According to an embodiment the emulsion polymerization is carried out by semi-continuous emulsion polymerization, in particular by pre-emulsified semi-continuous emulsion polymerization.

According to an embodiment the etherification of lignin is carried out in an inert atmosphere at alkaline conditions and in particular at a temperature of 30 to 90° C., for example 40 to 75° C.

According to an embodiment the method further comprises the steps of: adding sodium hydroxide into the lignin, adding, after dissolving of sodium hydroxide, a bi-functional monomer, such as allyl glycidyl ether, at a molar ratio of 1:1 to 1:4 based on phenolic hydroxyl group content of lignin, continuing the reaction until completion, for example for 5 to 24 hours, in particular for 8 to 10 hours in an nitrogen atmosphere.

According to an embodiment the method further comprises dialysis of the allylated lignin derivative with a membrane, for example having an exclusion size of at least 500 Da, such as 0.5 ˜14 kDa, to remove sodium hydroxide and unreacted monomer, said dialysis being carried out for a period of 1 to 180 h, for example 12 to 130 h, such as about 120 h, typically at room temperature.

According to an embodiment the method comprises carrying out the grafting reaction in the presence of a surfactant, such as sodium dodecyl sulphate or sodium dodecyl sulphonate, for example added in an amount of 0.1 to 2.5 wt %, in particular about 1 wt %, based on total weight of the alkyl-acrylate monomer, and by further adding a radical initiator, such as ammonium persulphate, potassium persulphate or sodium persulphate, in particular 2 wt % of the ammonium, potassium persulphate or sodium persulfate, based on total weight of alkyl-acrylate monomer, and carrying out the reaction in inert atmosphere, for example under nitrogen atmosphere, at a temperature in excess of 50° C., such as of about 80° C. for 1 to 10 hours, for example for about 7 hours.

According to an embodiment the method further comprises casting and drying the formed latex into a film, for example at 50° C. and 50% humidity lasting for 12 h.

According to an embodiment there is provided a biobased latex, especially water-borne latex, formed by the method described above comprising the steps of providing an allylated lignin ether derivative; and grafting the allylated lignin ether derivative with a poly(alkyl acrylate) by emulsion polymerization.

According to an embodiment there is provided a biobased film formed by the latex, especially water-borne latex, as described above comprising a lignin ether grafted with poly(alkyl acrylate) or by the method described above comprising the steps of providing an allylated lignin ether derivative; and grafting the allylated lignin ether derivative with a poly(alkyl acrylate) by emulsion polymerization.

The flexibility of the film can be determined by measuring the tensile stress and tensile strain. The flexibility is tested by cutting films into rectangle shape with 5 cm×5 mm and the films are mounted with a distance of 2 cm between the clamps. The films are stretched at a speed of 20 mm/min under room temperature. The film thickness is controlled around at 110 μm. Both the tensile stress and tensile strain are affected by the substitution degree during the polymerization reaction. The grafted polymer molecular chains were very long and flexible after the introduction of alkyl acrylate monomer in second step of graft polymerization, which was determined by the nature of the molecular structure of alkyl acrylate monomer, leading to the increase of the elongation at break without sacrificing the tensile stress. According to an embodiment, the film has a tensile strain at break of 400-3000%, preferably 600-3000%, in particular 800-2500%.

According to an embodiment the film has a maximum tensile stress of 1-6 MPa, preferably 2-10 MPa, in particular 3-8 MPa.

The hydrophobicity of the film is evaluated by the contact angle of a water droplet on its surface. According to an embodiment the film has a hydrophobicity with water contact angle of 50-90°, preferably 60-90°, in particular 70-90°. The hydrophobicity is tested based on water contact angle at 25° C. under 4 μL per drop condition.

According to an embodiment the thickness of the film is 80-300 μm, preferably 100-150 μm, in particular 120-150 μm.

According to an embodiment, the film has good thermal stability. The film has two distinct stages of decomposition. The first decomposition stage is at around 300° C., which attributes to the degradation of the lignin macromolecular chains. The second decomposition stage is at about 400-420° C., which corresponds to the decomposition of the alkyl acrylate grafted macromolecular chains.

According to an embodiment there is provided a biobased binder formed by the latex as described above comprising a lignin ether grafted with poly(alkyl acrylate) or by the method described above comprising the steps of providing an allylated lignin ether derivative; and grafting the allylated lignin ether derivative with a poly(alkyl acrylate) by emulsion polymerization.

According to an embodiment the binder has a tensile bond stress at break of 1-5MPa, preferably 1.2-4.5 MPa, in particular 1.5-4 MPa when measured in a tensile test with two pieces of wood having 1.5×1.5 cm2 surface area.

According to an embodiment the latex provided as described above is used for coating applications, such as coatings for paper, paperboard or sand paper, preferably in food-packaging, in water purification as a membrane and for cosmetics packaging. Thus, according to one embodiment, the latex can be used to form a membrane for water purification application.

According to an embodiment the latex provided as described above is used as a binder, such as binder in pigment coatings or paints, or as an adhesive, such as an adhesive for gluing wood and wood products, or composites.

The following non-limiting example illustrates an embodiment.

### EXAMPLES

### Example 1: Preparation of Allylated Lignin Nanoparticles (A-LNPs)

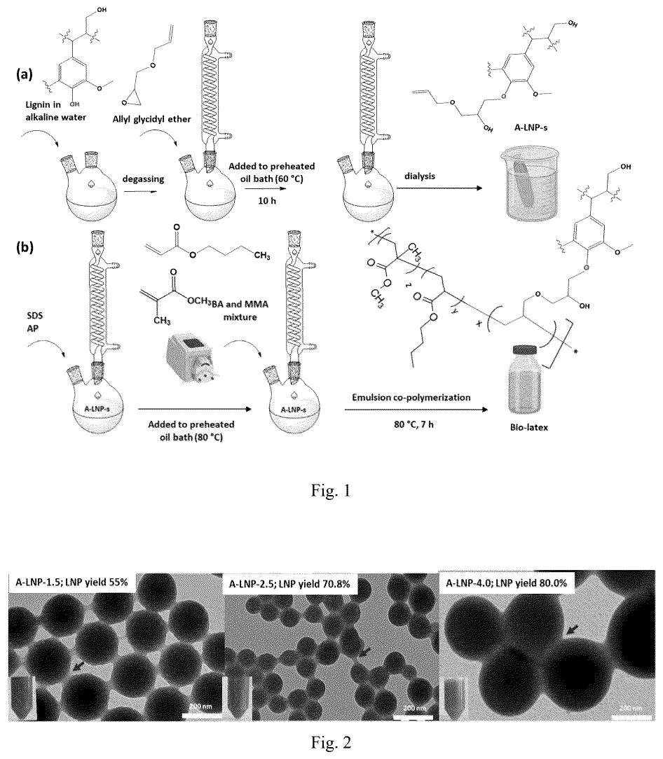

Functionalization of lignin hydroxyl groups using allyl glycidyl ether (AGE) was carried out by an anionic ring-opening reaction under alkaline conditions. First, 250 mg of lignin (birch-i-PrOH-s fraction, 5.7 mmol/g hydroxyl groups) was introduced to a two-necked round-bottom flask containing 10 ml of aqueous sodium hydroxide solution (0.2 g of NaOH, 0.5 M) under agitation (FIG. 1a). The two-necked round-bottom flask was equipped with a reflux condenser and immersed in an oil bath preheated to 60° C. 244 mg (2.14 mmol) of allyl glycidyl ether (AGE) was provided dropwise to the homogeneous lignin solution using a syringe through a septum in a nitrogen atmosphere and the reaction was left to stir for 10 hours. The reaction was terminated by cooling to ambient temperature. The reaction media was dialyzed against Milli-Q water using a 1000 Da dialysis membrane (Spectra/Por7, USA) to remove the unreacted reactants until the conductivity of the dialysis solution was close to Milli-Q water. Consequently, the A-LNP-1.5 dispersion sample was obtained. The same sample preparation procedure was carried out to obtain the A-LNP-2.5 and A-LNP-4.0 dispersion samples, while the amount of AGE was tuned to achieve different stoichiometric molar ratios to lignin hydroxyl groups as listed in Table 1.

### Example 2: Preparation of A-LNPs-co-BA-MMA Latex Dispersion

Lignin-containing latex was prepared by free-radical emulsion polymerization of n-butyl acrylate (BA) and methyl methacrylate (MMA) with A-LNPs prepared in the first example as the locus of polymerization using sodium dodecyl sulfate (SDS) as the emulsifier and ammonium persulfate (AP) as the free radical initiator. The two-necked round-bottom flask containing 10 ml dispersion of A-LNP-2.5 (250 mg lignin) was degassed with nitrogen for 20 min and thereafter was equipped with a condenser and immersed in an oil bath preheated to 80° C. Then, SDS (12.5 mg, 0.04 mmol) and AP (12.5 mg, 0.05 mmol) were introduced to the dispersion in a nitrogen atmosphere (FIG. 1b). Mixed acrylate monomers of BA (625 mg, 4.88 mmol) and MMA (625 mg, 6.24 mmol) with a total mass of 5-fold to the lignin were dropwise added by the peristaltic pump through the rubber septum sealed on the neck of the flask within 1 hour, thus initializing the polymerization. The reaction was performed under 400 rpm stirring with continuous nitrogen purging, and another portion of AP (12.5 mg, 0.05 mmol) was introduced to the reaction media at 4 hours. The reaction was terminated at 7 hours to obtain A-LNP-2.5-5 latex by cooling to room temperature. Same method was used also for other A-LNP samples.

In addition, the total weight of BA and MMA with an equal mass fraction was adjusted relative to the lignin content to target latex with different biocontent in terms of sample A-LNP-2.5 (see Table 1), whereas SDS and AP were set to 1 wt.-% and 2 wt.-% of total monomer content, respectively. Specifically, A-LNP-2.5-4 latex (250 mg lignin) was synthesized following the same procedure as for A-LNP-2.5-5 latex, while 500 mg BA and 500 mg MMA were subjected to polymerization with 10.0 mg SDS and 20.0 mg AP.

TABLE 1
Formulation of A-LNPs and A-LNPs-co-BA-MMA latex

| | AGE/lignin | AGE/lignin | MMA/BA | Lignin/acrylate |
|---|---|---|---|---|
| | (OH) feed ratio | feed ratio | ratio | monomer ratio |
| Latex | (molar) | (mass) | (molar) | (mass) |
| A-LNP-1.5-5 | 1.50 | 0.96 | 56:44 | 1:5 |
| A-LNP-2.5-5 | 2.50 | 1.61 | 56:44 | 1:5 |
| A-LNP-2.5-4 | 2.50 | 1.61 | 56:44 | 1:4 |
| A-LNP-2.5-3 | 2.50 | 1.61 | 56:44 | 1:3 |
| A-LNP-4.0-5 | 4.00 | 2.58 | 56:44 | 1:5 |

### Example 3: Characterization of the A-LNPs of Example 1

The A-LNPs were successfully prepared by selective allylation of the phenolic groups of lignin and the subsequent self-assembly in water according to example 1 and FIG. 1a.

Lignin allylation and nanoparticle surface functionalization were confirmed by ¹H NMR (proton nuclear magnetic resonance) spectroscopy. All ¹H NMR experiments were carried out on a Bruker AVANCE III 500 MHz spectrometer equipped with a 5 mm BBO CryoProbe. For the total allyl group quantification, A-LNPs were completely dissolved in DMSO-d6 with internal standard of 4-nitrobenzaldehyde (4-NBA). For the quantification of allyl groups distributed on the surface of A-LNPs, the A-LNPs were in dispersed in D₂O using 3-(trimethylsilyl) propionic-2,2,3,3-d₄ as internal standard. The measured properties of the produced A-LNPs are shown in Table 2. The results of Table 2 show that lignin has been allylated.

Further, Table 2 presents the glass transition temperatures of the A-LNP samples measured by DSC (differential scanning calorimetry). Based on the results, the glass transition temperature (T_{g}) of the A-LNPs was lower than that of the starting birch-i-PrOH-s lignin and decreased with increasing allyl modification degree, ranging from 80 to 48° C. It indicates that varying the allyl modification degree on lignin may considerably change the intermolecular interactions and physicochemical properties of macromolecules from lignin.

TABLE 2
The physicochemical properties of the produced A-LNPs.

| | | ¹H NMR (D₂O) | |
|---|---|---|---|
| | ¹H NMR (DMSO-d6) | allyl on LNP surface | DSC |
| Lignin | total allyl (mmol/g) | (mmol/g A-LNP) | T_{g} (° C.) |
| birch-i-PrOH-s | — | — | 125 |
| A-LNP-1.5 | 2.35 | 1.2 | 57 |
| A-LNP-2.5 | 2.97 | 1.4 | 48 |
| A-LNP-4.0 | 2.58 | 1.3 | 77 |

The lignin nanoparticle surface functionalization was also evident from TEM (transmission electron microscopy) measurement, the results of which are shown in FIG. 2. FIG. 2 comprises TEM images of A-LNP-1.5, A-LNP-2.5 and A-LNP-4.0 in which the surface functionalization is indicated by the arrows.

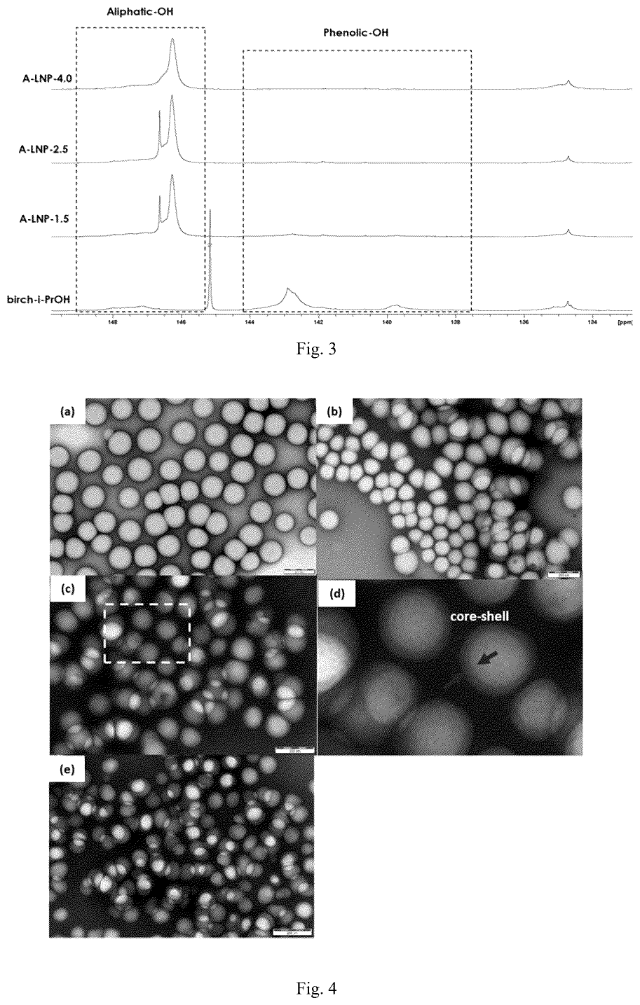

Further, hydroxyl group distribution in A-LNPs was determined with ³¹P NMR spectroscopy, the results of which are shown in FIG. 3 and Table 3. The amount of aliphatic-OH increased due to the ring-opening reaction of the oxirane groups in allyl glycidyl ether. The amount of total phenolic-OH groups decreased in the order of A-LNP-1.5, A-LNP-2.5 and A-LNP-4.0. The lowest phenolic OH-group amount was found for A-LNP-4.0 with 0.2 mmol/g, which has a 93% decrease compared to that of birch-i-PrOH lignin control sample (2.88 mmol/g). The allylation process did not significantly alter the amount of carboxylic acid (—COOH) groups, thus, 31P NMR results indicate that the allylation process was selective toward phenolic hydroxyl groups.

TABLE 3
The hydroxyl group distribution of A-LNPs,
including initial birch-i-PrOH lignin.

| | Aliphatic-OH | Phenolic-OH | —COOH | Total OH |
|---|---|---|---|---|
| Lignin | (mmol/g) | (mmol/g) | (mmol/g) | (mmol/g) |
| birch-i-PrOH | 0.86 | 2.88 | 0.97 | 5.68 |
| control | | | | |
| A-LNP-1.5 | 3.10 | 0.58 | 0.36 | 4.04 |
| A-LNP-2.5 | 3.43 | 0.37 | 0.33 | 4.13 |
| A-LNP-4.0 | 3.08 | 0.20 | 0.64 | 3.92 |

### Example 4: Characterization of the A-LNPs-co-BA-MMA Latex Dispersion and Film of Example 2

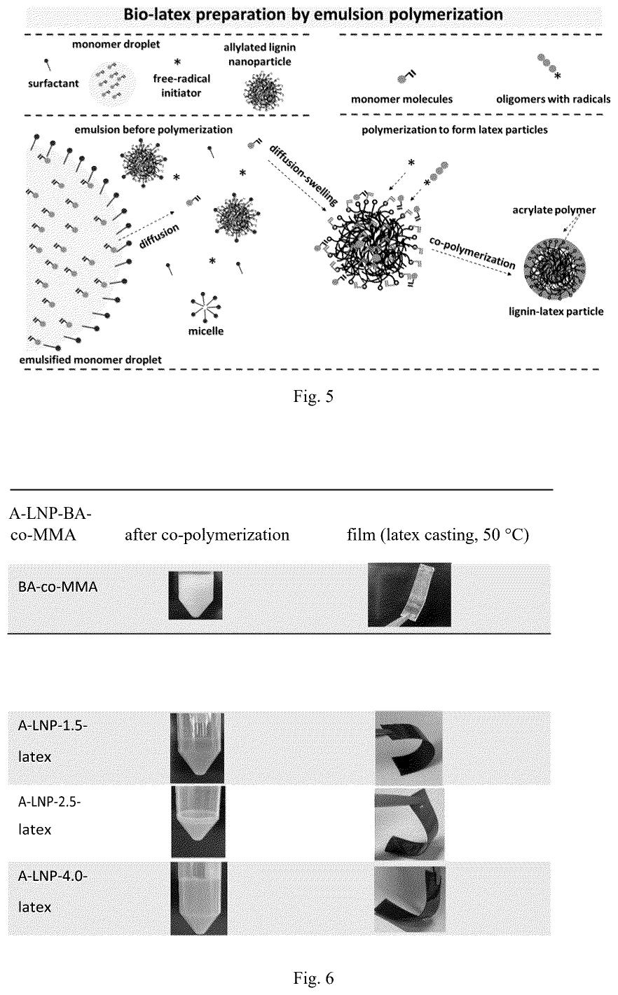

The surface-initialized polymerization of A-LNPs with acrylate monomers was confirmed by TEM measurement using uranyl acetate negative staining method, the results are shown in FIG. 4. Thus, FIG. 4 shows the TEM images of latex synthesized as a function of the grafting amount of allyl groups: (a) BA-co-MMA, (b) A-LNP-1.5 latex, (c) A-LNP-2.5 latex, and (e) A-LNP-4.0 latex. Selected core-shell structure particles of A-LNP-2.5 latex are indicated by the arrows (FIG. 4d). In the latex, the allyl groups distributed on the surface of A-LNPs serve as anchors to “suck” acrylate monomers and then act as locus of polymerization. More specifically, the acrylate monomers and radicals penetrated into the seeded A-LNPs driven by the surface allyl groups (FIG. 5). Subsequently, the acrylate polymer chains both interpenetrated inside and adhered on the surface of A-LNPs through free radical emulsion co-polymerization. Lignin nanoparticle interpenetrated polymer network provides the core-shell structured morphology to the bio-latex.

### Example 5. Preparation of A-LNPs-co-BA-MMA Latex Film

The bio-latex formed in example 2 were cast on a petri dish for drying at 50° C. for 12 h to obtain a free-standing film. Alternatively, the bio-latex dispersion of sufficient thickness could have been coated onto paper by draw-down coating. The latex after co-polymerization and the films casted thereof are shown in FIG. 6.

Polymer nanocomposites constitute of the nanoparticles in the polymer matrix. Lignin nanoparticles of the present invention posses spherical shape and colloidal stability compared to bulk lignin and other biopolymer, which ensures the dispersion stability during emulsion polymerization process and also guarantee the quality of the cast film due to its surface functionality. The stability of the formed latexes is shown in FIG. 6 (left side pictures of the uniform latex).

### Example 6. Characterization of A-LNPs-co-BA-MMA Latex Film

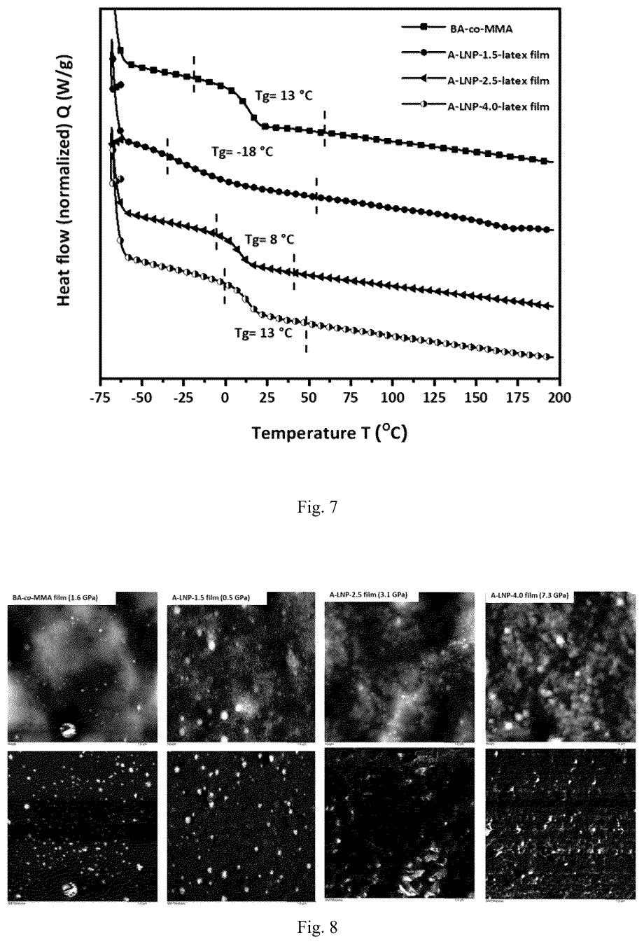

Glass transition temperatures of the bio-latex films formed in example 5 were measured by DSC (differential scanning calorimeter), the DSC curves of BA-co-MMA, A-LNP-1.0 latex films, A-LNP-1.5 latex film, A-LNP-2.5 latex film and A-LNP-4.0 latex film are shown in FIG. 7. The DSC program used: ramp 10.00° C./min to 200° C., isothermal 10 min, ramp 20.00° C./min to-80° C., ramp 20.00° C./min to 200° C.

Based on FIG. 7, the DSC curves of A-LNP-2.5 and A-LNP-4.0 latex films show only one strong T_{g}, suggesting the strong thermal dynamic compatibility between A-LNPs and BA-co-MMA copolymer without phase separation, which was attributed to the covalent interactions. In addition, compared to the T_{g} of A-LNPs ranging from 48 to 80° C. and the T_{g} of random BA-co-MMA copolymer at 13° C. at the same monomer composition, the T_{g} of A-LNP latex film, shifted to the direction of lower temperature reveals the existence of a penetrating polymer network in lignin-nanoparticle containing latex.

Finally, stiffness of the latex were investigated. Stiffness modulus of latex films were measured from AFM (atomic force microscopy) and that aligned well with Young's modulus estimated from tensile test. FIG. 8 shows AFM (a) topographic (up) and (b) DTM (Derjaguin-Muller-Toporov) stiffness modulus (bottom) images of the latex film samples BA-co-MMA, A-LNP-1.5, A-LNP-2.5 and A-LNP-4.0 latex films. Table 4 presents the comparison of Young's modulus estimated from different measurement (AFM and tensile test).

TABLE 4
Young's modulus estimated from different measurements.

| | DMT stiffness | Elastic modulus |
|---|---|---|
| | modulus (GPA) | (MPa) |
| Film | AFM_{PF-QNM} | DMAₛₜᵣₑₛₛ₋ₛₜᵣₐᵢₙ |
| BA-co-MMA | 1.6 | 5.4 |
| A-LNP-1.5 latex | 0.5 | 5.7 |
| A-LNP-2.5 latex | 3.1 | 6.9 |
| A-LNP-4.0 latex | 7.3 | 21.5 |

Compared with BA-co-MMA, the A-LNP-1.5 latex film exhibited lower stiffness but higher value of elongation at break, which is attributed to its low T_{g} behaviour. The latex film with higher T_{g} also possessed higher stiffness modulus, for example A-LNP-2.5 and A-LNP-4.0 latex films. Compared with the AFM stiffness modulus images of BA-co-MMA, the spherical and stiff nanoparticles in A-LNP-4.0 film are contributed by the incomplete coalescence during the film forming process, at which point particles still retain their morphologies and boundaries, respectively.

### Example 7. Use of A-LNPs-co-BA-MMA Latex Dispersion as a Binder for Dispersion Coating Application

The bio-latex formed in example 2 was mixed with a pigment filler (kaolin) and a rheology modifier (carboxymethyl cellulose sodium salt, CMC). Kaolin was used as a kaolin dispersion having a solid content of 65 wt. % and CMC had a solid content of 3 wt. %. The bio-latex of example 2 was concentrated by centrifugation and redispersed to a solid content of 40-50 wt. %. The components were mixed with a mixing speed of 20 000 rpm, after which at least most of the formed bubbles were removed by the combination of vacuum and sonification.

Three samples were produced, each comprising 1 wt. % of the CMC, Oct. 20, 1930 wt. % of kaolin and the rest being the bio-latex, calculated from the dry weight of the composition. See Table 5 for compositions of the dispersion samples.

TABLE 5
Compositions of the dispersion samples

| | Ratio (wt. % based on dry weight) | | | |
|---|---|---|---|---|
| Components | Reference | Sample 1 | Sample 2 | Sample 3 |
| Lignin latex | 100 | 89 | 79 | 69 |
| Kaolin | — | 10 | 20 | 30 |
| CMC | — | 1 | 1 | 1 |

The formed dispersion were coated on a paperboard to form a pigment-coated paperboard. The coating was performed by a Mayer rod coating method, the coating having a wet thickness of 100 μm. The coated paperboards were subjected to IR (infrared) drying for 20 seconds and then subjected to quality testing. Based on the quality tests, the coated paper showed good thickness, air permeability and roughness (see the results in Table 6). The coated surface of the paper did not stick to another surface when pressure was applied, i.e. the coating has a good blocking resistance. Further, the paper porosity was low when tested with ethanol (95% EtOH) staining with sudan red (0.1 wt. %), which was shown by full coverage of the red colour.

TABLE 6
Quality test results of lignin-latex coated paper

| Parameter | “Criteria” | Base paper | Reference | Sample 1 | Sample 2 | Sample 3 |
|---|---|---|---|---|---|---|
| Coat weight (g/m²) | 40-50 | — | 40.8 | 47.1 | 49.4 | 54.3 |
| Thickness before | 40-50 | — | 40.0 | 40.1 | 39.7 | 47.7 |
| calendaring (μm) | | | | | | |
| Air permeability | the higher | 15400 | 42300 | 42300 | 42300 | 42300 |
| (Gurley s.) | the better | | | | | |
| Roughness (μm) | 5-10 | 1.62 ± 0.03 | 4.36 ± 1.03 | 3.88 ± 2.04 | 4.68 ± 1.54 | 8.47 ± 3.41 |

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### INDUSTRIAL APPLICABILITY

The latexes according to the current invention can be used as glues, adhesives and binders. Particularly, they can be used as glues and adhesives in wood-based products such as plywood or as binders in applications such as pigment coatings and paints. The films according to the current invention can be used as films in packaging materials, such as to replace aluminum foil, PE, PP, PVDC or EVOH, for food, cosmetics and pharmaceuticals or as barrier coatings for paper and paperboard. Also, the latexes according to the current invention can be used in swim caps, chewing gum, mattresses, catheters, rubber bands, balloons, tennis shoes, and many other sporting goods. In other applications, latex can also be added to cement used for resurfacing and patching cracks in cement surfaces.

### ACRONYMS LIST

AFM Atomic force microscopy
AGE Allyl glycidyl ether
A-LNP Allylated lignin nanoparticles
AP Ammonium persulfate
BA N-butyl acrylate
DSDegree of substitution
DSC Differential scanning calorimetry
EVOH Ethylene vinyl alcohol
MMA Methyl methacrylate
NMR Nuclear magnetic resonance
PE Polyethylene
PP Polypropylene
PVDC Polyvinylidene chloride
SDS Sodium dodecyl sulfate
TEM Transmission electron microscopy

1-35. (canceled)

36. A lignin ether grafted with poly(alkyl acrylate), wherein the poly(alkyl acrylate) is grafted to an allylated lignin ether derivative.

37. The lignin ether according to claim 36, wherein the poly(alkyl acrylate) is grafted to allylic ether groups on the lignin.

38. The lignin ether according to claim 36, the allylated lignin ether derivative is obtained by reacting lignin exhibiting phenolic hydroxyl groups with a bi-functional reactant containing reactive groups and unsaturated groups.

39. The lignin ether according to claim 38, wherein the bi-functional reactant comprises epoxy groups and vinyl or allyl groups.

40. The lignin ether according to claim 36, wherein the lignin ether grafted with poly(alkyl acrylate) is obtained by polymerization of an alkyl acrylate monomer or an alkyl (alk)acrylate monomer, or a combination thereof, in the presence of lignin ether.

41. The lignin ether according to claim 36, wherein the lignin is selected from the group consisting of unmodified lignin, alkali lignin, non-sulphurous lignin, Kraft lignin, LignoBoost lignin or LignoForce lignin.

42. The lignin ether according to claim 36, comprising lignin in which at least 80 mol % of the phenolic hydroxyl groups have been converted to allylic ether groups.

43. The lignin ether according to claim 36, wherein allylic lignin ether is subjected to copolymerization with a combination of alkyl acrylate and alkyl (alk)acrylate monomers, said combination comprising alkyl acrylate and alkyl (alk)acrylate monomers at a molar ratio of 20:80 to 80:20.

44. The lignin ether according to claim 43, wherein the alkyl acrylate monomer is selected from the group consisting of ethyl acrylate, n-propyl acrylate, isopropyl acrylate, n-butyl acrylate, and isobutyl acrylate and combinations thereof, and the alkyl (alk)acrylate is selected from the group consisting of methyl methacrylate, n-hexyl methacrylate, n-octyl methacrylate, isooctyl acrylate monomers and combinations thereof.

45. A latex comprising the lignin ether grafted with poly(alkyl acrylate) according to claim 36.

46. The latex according to claim 45, comprising lignin particles having a Z-average particle size of about 120 to 250 nm, determined by a Zeta-sizer Nano ZS90 type laser nanometer particle size analyzer (Malvern, UK) with a 633 nm red laser.

47. The latex according to claim 45, having a T_{g} of 15° C. or less.

48. The latex according to claim 45, comprising lignin nanoparticle segments and acrylic polymer particle segments which are chemically or physically bonded to each other.

49. The latex according to claim 48, wherein the lignin nanoparticle segments have a hard core, and wherein the acrylic polymer particle segments have a soft shell.

50. The latex according to claim 45, having a content of lignin of up to 25%, calculated from the solid matter of the latex.

51. A method of manufacturing a emulsion, comprising the steps of:
providing an allylated phenolic ether derivative of lignin; and
grafting the allylated lignin ether derivative with a poly(alkyl acrylate) by emulsion polymerization to form a lignin ether grafted with poly(alkyl acrylate).

52. The method according to claim 51, wherein the allylated lignin ether derivative is obtained by reacting lignin with a bi-functional reactant comprising reactive groups and unsaturated groups to chemically bond to lignin by etherification.

53. The method according to claim 52, wherein the bi-functional reactant is allyl glycidyl ether.

54. The method according to claim 52, wherein the bi-functional reactant is allyl bromide, allyl chloride, or a mixture thereof.

55. The method according to claim 51, wherein the allylated lignin ether derivative is obtained by reacting lignin with a bi-functional reactant comprising epoxy groups and vinyl or allyl groups to chemically bond to lignin by etherification.

56. The method according to claim 51, wherein etherification is carried out in aqueous phase at an alkaline pH.

57. The method according to claim 51, wherein the allylated phenolic ether derivative is subjected to dialysis to lower the pH and to allow for self-assembly of the ether derivative.

58. The method according to claim 51, comprising copolymerizing a combination of alkyl acrylate and alkyl (alk)acrylate monomers, said combination comprising alkyl acrylate and alkyl (alk)acrylate monomers at a molar ratio of 20:80 to 80:20, in the presence of an allylated phenolic ether derivative of lignin.

59. The method according to claim 51, wherein the alkyl-acrylate monomer is selected from the group consisting of ethyl acrylate, n-propyl acrylate, isopropyl acrylate, n-butyl acrylate, isobutyl acrylate, methyl methacrylate n-hexyl methacrylate, n-octyl methacrylate and isooctyl acrylate monomers and combinations thereof.

60. The method according to claim 51, wherein etherification of lignin is carried out in an inert atmosphere at alkaline conditions at a temperature of 30 to 90° C.

61. A water-borne latex formed by the method according to claim 51.
